(19) United States
(12) Patent Application Publication
(10) Pub. No.: US 2004/0111704 A1
(43) Pub. Date: Jun. 10, 2004

(54) Method and apparatus for extracting enterprise beans from servlet source codes

(76) Inventors: Dong Kwan Kim, Daejeon (KR); Jung Eun Cha, Daejeon (KR); Chul Hong Kim, Daejeon (KR); Hyo Taeg Jung, Daejeon (KR); Moon Sub Song, Jeonju-si (KR); Young Jong Yang, Daejeon (KR)

Correspondence Address: JACOBSON HOLMAN PLLC, 400 SEVENTH STREET N.W., SUITE 600, WASHINGTON, DC, 20004, US

(21) Appl. No.: 10/636,599

(22) Filed: Aug. 8, 2003

(30) Foreign Application Priority Data
Dec. 10, 2002 (KR) 10-2002-0078425

(51) Int. Cl. G06F 9/44; G06F 9/45

(52) U.S. Cl. 717/116; 717/136; 717/118; 717/108

(57) ABSTRACT

In an apparatus for extracting enterprise beans from a servlet source code, a servlet source code input device receives the servlet source code and a Java class. A Java class extraction device extracts Java classes from the servlet source code. A Java class clustering device groups the Java classes on the basis of interrelated classes. A session bean extraction device and an entity bean extraction device extract a session bean and an entity bean from the clustered classes, respectively. An enterprise bean relationship information extraction device extracts relationship information between enterprise beans from the extracted session bean and entity bean.

### FIELD OF THE INVENTION

The present invention relates to an enterprise bean extraction; and, more particularly, to a method and an apparatus for extracting enterprise beans, which is suitable for effectively extracting a session bean and an entity bean from servlet source codes.

### BACKGROUND OF THE INVENTION

A web environment in 1990s causes various software from a bulletin board system (BBS) to an electronic commerce to be developed, and further leads to a continuous development of diverse web-based applications. As a result, an off-line business such as financing, administration, education and the like has been adjusted to a web environment. And also, conventional systems provide a means for interfacing with the web environment. Further, a software development environment has changed, so that programming languages and supporting devices capable of more effectively supporting the web environment are being developed.

An example of a programming language for web-based software development is a Java-based servlet developed by “SUN Microsystems”. Such servlet is being widely used by Java language users, since a deficiency of a common gateway interface (CGI) can be attenuated when it is used for building a website.

Meanwhile, software reuse comes to be highlighted due to a development of a plurality of servlet-based websites. Since web applications have similar function in similar domains as conventional software, it is possible to reuse corresponding functions. For example, if a banking system is constructed as a web-based application, various banking services e.g., a credit service and a lending service are implemented as a component, and thus can be reused when other application in a similar domain is constructed.

A software reuse technology as the distinguished theme of the software engineering has been researched from a copy & paste technique to a current software component technique. Depending on a unit of the reuse or a developing stage to be reused during a software development cycle, various concepts and techniques on the software reuse have been introduced and further are being applied to a software development. And also, a change of a computing environment leads to a reuse technology for supporting a specific application.

As a component model presently being on the rise, there is a Java based enterprise Java bean (EJB) of SUN Microsystems, Inc. The enterprise Java bean provides services through an external interface as a component model of a server end and an inside of the component is formed of a black box. Further the enterprise bean is provided with services required in distributed applications through middleware referred to as a container. The enterprise java bean relates classes including a remote interface for defining externally provided services, a home interface for creating and detecting functions, and an enterprise bean for implementing the externally provided services, wherein the enterprise bean is roughly classified into an entity bean and a session bean.

The session bean provides business logics of a specific domain as a method. Since the session bean is not shared between clients, one session bean is activated for one client. Further, since the session bean is non-persistent, data of the session bean is not stored in a database. Accordingly, the session bean is used in case there is no need to share a bean and the bean is not a persistent state.

On the other hand, the entity bean represents a business object in a persistent storage device such as the database. The entity bean is distinguished from the session bean in that the entity bean is persistent and allows shared access and has primary key. What is meant by the persistency is that the state of the bean is maintained after an application has completed.

And also, one entity bean can be shared by a plurality of client. In other words, the plurality of clients shares one entity bean and can modify data of the corresponding entity bean. Moreover, each entity bean has a unique object identifier. For example, in case of an entity bean representing a bank customer, a resident registration number of the customer can be used as a primary key.

In the past, techniques for transforming a legacy program such as COBOL or PL/I into the enterprise bean-based program were widely used, so that the legacy system can be applied to a web environment. Further, because of characteristics of the component, the reusability of the business logics is increased and new functions can be easily added to the legacy system.

FIG. 1 is a block diagram for showing an enterprise bean transformation apparatus applied to a general legacy program. Specifically, the apparatus is used for transforming the legacy program such as COBOL or PL/I into the enterprise bean-based program by extracting enterprise beans.

As can be seen from FIG. 1, an enterprise bean transformation apparatus 102 transforms a conventional legacy program 101 used for banking, administration or the like into an enterprise bean program 107.

The enterprise bean transformation apparatus 102 includes a legacy code analysis unit 103 for receiving and analyzing a legacy source code, a legacy code visualization unit 104 for visualizing the analyzed legacy code as a graph so that a developer can easily understand, a legacy code enterprise bean extraction unit 105 for extracting enterprise beans based on the analysis result of the legacy code analysis unit 103, an enterprise bean creation unit 106 for creating a Java source code based on information on the extracted enterprise beans.

In prior arts, it is a legacy program that is to be a target system used for extracting enterprise beans. Depending on the target system, functions of the legacy code analysis unit 103, the legacy code visualization unit 104 and the enterprise bean extraction unit 105 are changed.

However, since there is no method and supporting device for extracting a component from a servlet-based web program, a componentization process for a servlet source code mainly depends on a handling of a developer. The componentization processed by the handling requires considerable time and costs, so that is required an improvement on effective development by using of an enterprise bean component.

### SUMMARY OF THE INVENTION

It is, therefore, an object of the present invention to provide a method and an apparatus for extracting enterprise beans from a servlet source code, which is capable of reducing time and costs for developing a new web application by reusing business logics of a conventional web application developed based on a servlet.

In accordance with one aspect of the present invention, there is provided an apparatus for extracting enterprise beans from a servlet source code, including: a servlet source code input device for receiving the servlet source code and a Java class; a Java class extraction device for extracting Java classes from the servlet source code inputted by the servlet source code input device; a Java class clustering device for grouping the Java classes extracted by the Java class extraction device on the basis of interrelated classes; a session bean extraction device for extracting a session bean from the classes clustered by the Java class clustering device; an entity bean extraction device for extracting an entity bean from the classes clustered by the Java class clustering device; and an enterprise bean relationship information extraction device for extracting relationship information between enterprise beans from the session bean and the entity bean respectively extracted from the session bean extraction device and the entity bean extraction device.

In accordance with another aspect of the present invention, there is provided a method for extracting enterprise beans from a servlet source code, including the steps of: (a) receiving the servlet source code and a Java class; (b) extracting the Java class from the servlet source code; (c) checking whether or not a structured query language (SQL) statement is included in the extracted Java class; (d) extracting a session bean from the Java class if it is checked in the step (c) that the SQL statement is not included in the Java class; and (e) extracting an entity bean from the Java class if it is checked in the step (c) that the SQL statement is included in the Java class.

### BRIEF DESCRIPTION OF THE DRAWINGS

The above and other objects and features of the present invention will become apparent from the following description of preferred embodiments, given in conjunction with the accompanying drawings, in which:

FIG. 1 shows a block diagram for illustrating an enterprise bean transformation apparatus for a legacy program;

FIG. 2 describes a block diagram for depicting an enterprise bean transformation apparatus for a servlet-based web program in accordance with the present invention;

FIG. 3 provides an exemplary drawing for illustrating a system configuration of the servlet-based web program in accordance with the present invention;

FIG. 4 presents an exemplary drawing for showing a system configuration of an enterprise bean-based web program in accordance with the present invention;

FIG. 5 represents a block diagram for illustrating an enterprise bean extraction apparatus in accordance with the present invention;

FIG. 6 explains a detailed diagram of a session bean extraction unit shown in FIG. 5;

FIG. 7 demonstrates a detailed diagram of an entity bean extraction unit illustrated in FIG. 5;

FIG. 8 offers a flow chart for describing processes for extracting enterprise beans from a servlet source code in accordance with the present invention;

FIG. 9 sets forth a flow chart for demonstrating a Java class clustering for the entity bean in accordance with the present invention;

FIG. 10 depicts a table for showing mapping relations between structured query language (SQL) sentences and entity bean methods in accordance with the present invention; and

FIG. 11 illustrates an exemplary drawing for explaining an operation of the enterprise bean extraction apparatus in accordance with the present invention.

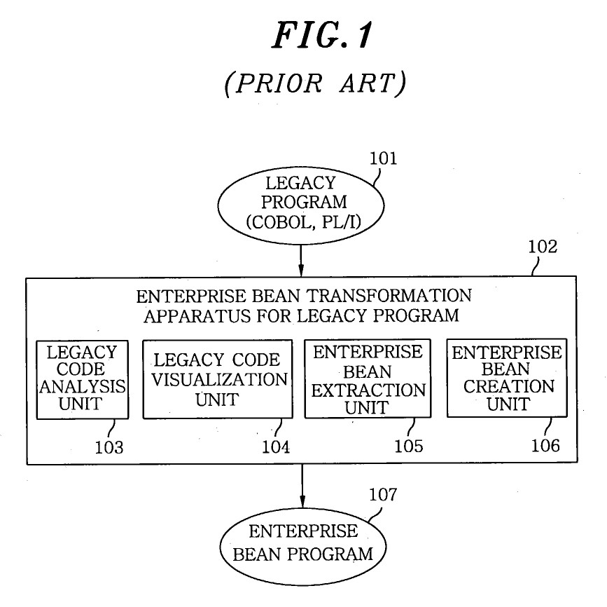

### DETAILED DESCRIPTION OF THE PREFERRED EMBODIMENTS

Hereinafter, preferred embodiments of the present invention will be described in detail with reference to the accompanying drawings.

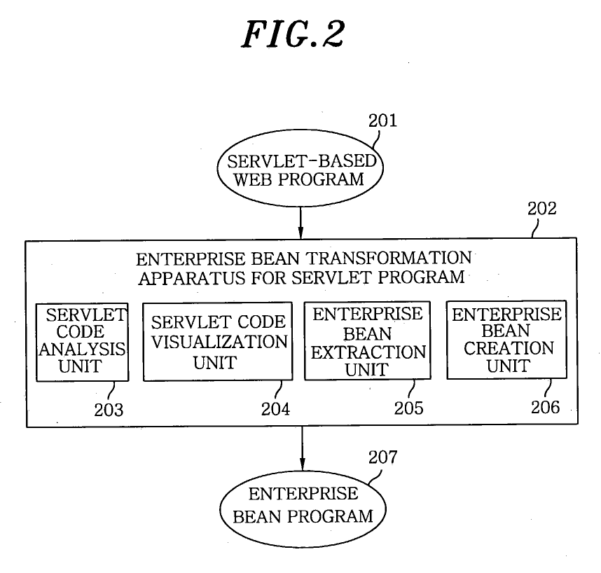

FIG. 2 describes a block diagram for depicting an enterprise bean transformation apparatus for a servlet-based web program in accordance with the present invention. Specifically, the apparatus transforms the servlet-based web program into an enterprise bean-based program by extracting enterprise beans from the servlet-based web program.

As illustrated in FIG. 2, a servlet-based web program 201 is transformed into an enterprise bean-based program 207 through an enterprise bean transformation apparatus 202. The enterprise bean transformation apparatus 202 includes a servlet code analysis unit 203 for receiving and analyzing a servlet source code, a servlet code visualization unit 204 for showing the analyzed servlet code as a graph so that a developer can easily understand the analyzed servlet code, a servlet enterprise bean extraction unit 205 for extracting enterprise beans based on the analyzing result of the servlet code analysis unit 203, and an enterprise bean creation unit 206 for creating a Java source code based on information on the extracted enterprise beans.

The servlet code analysis unit 203 analyzes meta information, e.g., a class name, a package name, a method name and the like, which are required for extracting enterprise beans. Further, the servlet code analysis unit 203 analyzes SQL sentences, e.g., “select, update, delete, insert”, included in a servlet and a Java class and then transmits the analyzing result to the servlet enterprise bean extraction unit 205.

The servlet code visualization unit 204 provides various graphs or unified modeling language (UML)-based diagrams in order to show the servlet source code, wherein the diagrams include a class diagram indicating the servlet, the Java class and a relation therebetween and a component diagram indicating the extracted enterprise beans and a relation therebetween.

The servlet enterprise bean extraction unit 205 extracts a session bean and an entity bean. An entity bean is extracted based on a SQL statement and the extracted entity bean represents a database table to which the input servlet program accesses. In comparison with a session bean extraction process, an entity bean extraction process includes a finder method extraction process.

The enterprise bean creation unit 206 generates the Java source code based on the extracted enterprise bean information.

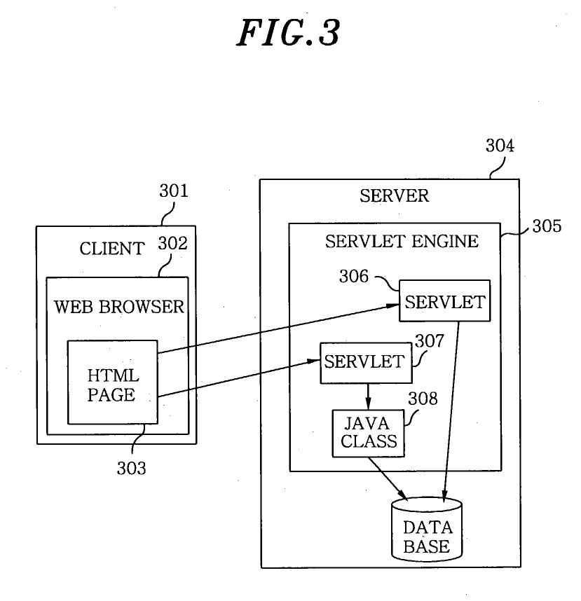

FIG. 3 provides an exemplary drawing for illustrating a system configuration of the servlet-based web program in accordance with the present invention.

As can be seen from FIG. 3, a client 301 communicates with a server 304 through a hypertext markup language (HTML) page 303 of a web browser 302. At this time, a service request transmitted through the HTML page 303 is sent to a servlet 306 of the server 304. Servlets 306 and 307 managed by a servlet engine 305 access to a database 309 directly or indirectly through a Java class 308 and process the request of the client 301. And then the result thereof is returned.

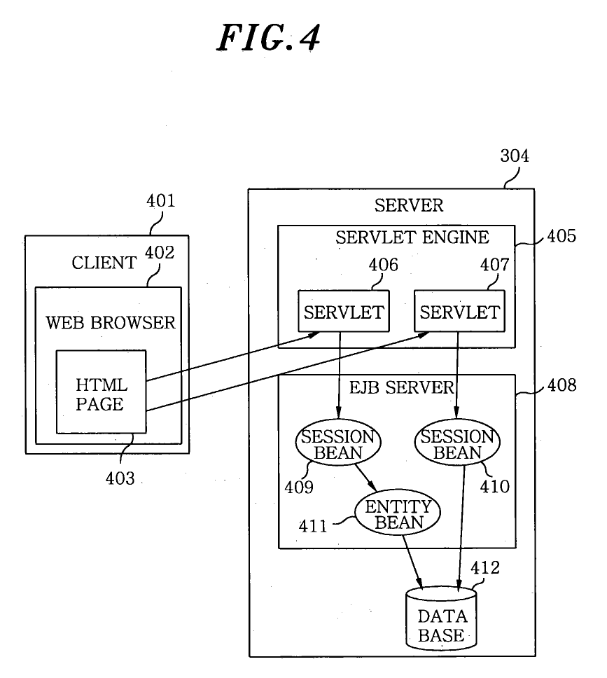

FIG. 4 presents an exemplary drawing for showing a system configuration of an enterprise bean-based web program in accordance with the present invention. The servlet-based web program shown in FIG. 3 is transformed into the enterprise bean-based web program illustrated in FIG. 4.

As illustrated in FIG. 4, a request of a client 401 is transmitted to servlets 406 and 407 managed by a servlet engine 405 through a HTML page 403. The corresponding servlets 406 and 407 access to a database 412 through a session bean 409 and an entity bean 411 managed by an EJB server 408, and then process the request of the client 401. The result thereof is returned to the client 401 through the servlets.

The EJB server 408 manages a life cycle of enterprise beans from creation to extinction thereof. While business logics are scattered in the servlets and the Java class shown in FIG. 3, the enterprise beans illustrated in FIG. 4 include business logics. Therefore, the reuse of the business logics is possible.

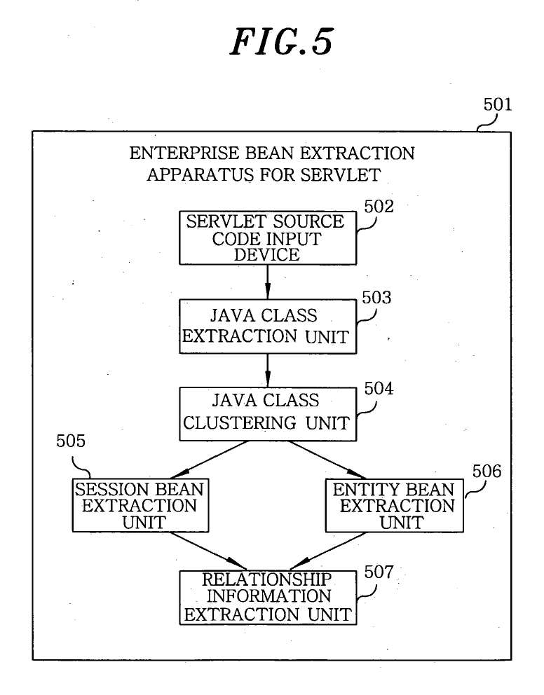

FIG. 5 represents a block diagram for illustrating an enterprise bean extraction apparatus in accordance with the present invention. A servlet enterprise bean extraction unit 501 includes a servlet source code input unit 502 for receiving a servlet source code, a Java class extraction unit 503 for extracting Java classes from the inputted servlet source code, a Java class clustering unit 504 for grouping the extracted Java classes on the basis of interrelated classes, a session bean extraction unit 505 for extracting a session bean from the grouped classes, an entity bean extraction unit 506 for extracting an entity bean from the grouped classes, and a relationship information extraction unit 507 for extracting relationship information between the extracted session bean and entity bean.

FIG. 6 explains a detailed diagram of the session bean extraction unit 505 in the enterprise bean extraction unit 501 shown in FIG. 5, wherein the session bean extraction unit 505 includes a session bean class extraction unit 601, a session bean remote interface extraction unit 602 and a session bean home interface extraction unit 603.

The session bean class extraction unit 601 extracts a session bean class including real implementation of the methods that are provided to a client through a remote interface and a home interface.

The session bean remote interface extraction unit 602 extracts the remote interface of the session bean. The remote interface provides methods for operating business logics to a client.

The session bean home interface extraction unit 603 extracts the home interface of the session bean. The home interface has a creation method and a finder method of the session bean.

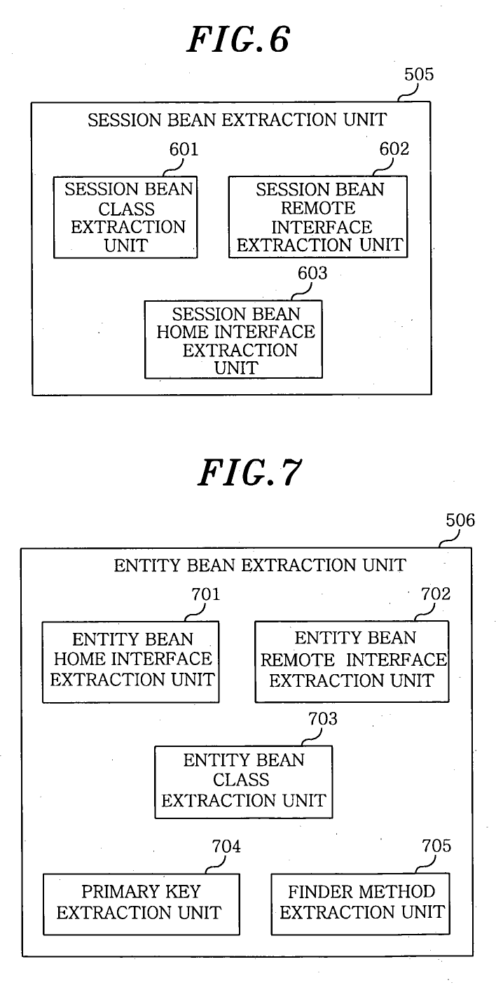

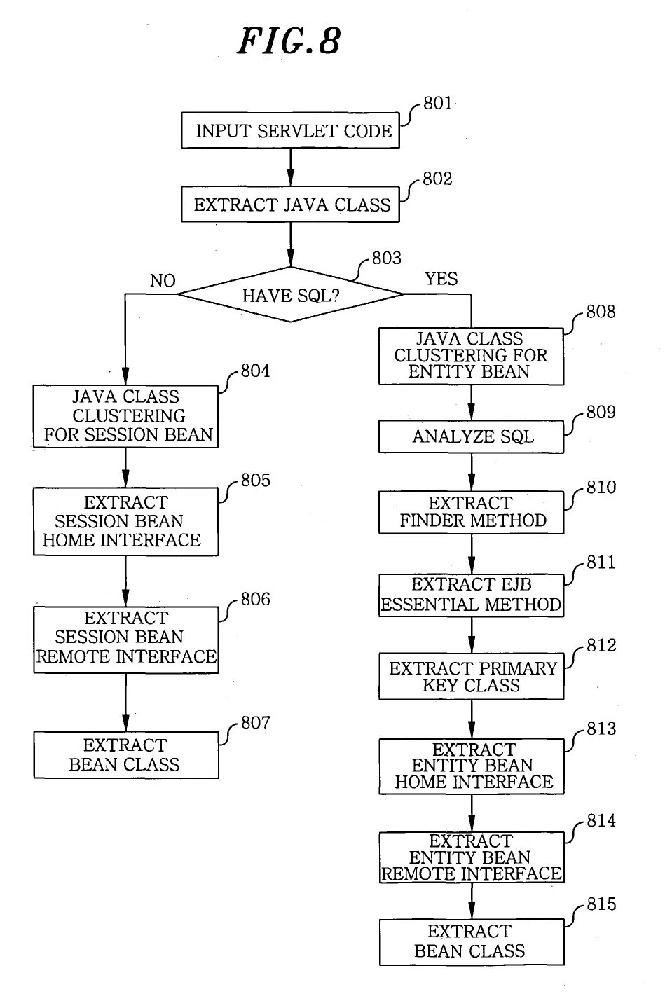

FIG. 7 demonstrates a detailed diagram of the entity bean extraction unit 506 in the enterprise bean extraction unit 501 illustrated in FIG. 5. The entity bean extraction unit 506 includes an entity bean home interface extraction unit 701, an entity bean remote interface extraction unit 702, an entity bean class extraction unit 703, a primary key extraction unit 704 and a finer method extraction unit 705.

The entity bean home interface extraction unit 701 and the entity bean remote interface extraction unit 702 extract a home interface and a remote interface of an entity bean, respectively.

The entity bean class extraction unit 703 and the primary key extraction unit 704 extract a bean class and a primary key class of the entity bean, respectively. The primary key class substitutes for a primary key of a database table.

The finder method extraction unit 705 extracts a finder method corresponding to one of the basic methods of the entity bean.

FIG. 8 offers a flow chart for describing a procedure for extracting enterprise beans from a servlet source code in accordance with the present invention.

The enterprise bean extraction process involves inputting a servlet code (step 801), extracting a Java class from the servlet code (step 802), checking whether or not a SQL sentence is included in the Java class (step 803), performing a Java class clustering for a session bean (step 804), extracting a session bean home interface (step 805), extracting a session bean remote interface (step 806), extracting a session bean class (step 807), performing a Java class clustering for an entity bean (step 808), analyzing the SQL sentence (step 809), extracting a finder method (step 810), extracting an EJB essential method (step 811), extracting a primary key class (step 812), extracting an entity bean home interface (step 813), extracting an entity bean remote interface (step 814) and extracting an entity bean class (step 815).

The step 802 is a process for extracting a new Java class by analyzing the inputted servlet code. Specifically, a HTML code included in the servlet code and a code using a servlet application program interface (API) are removed. Then, a servlet method for processing a request of a client, e.g., “dopost( ), doGet( ), service( )”, is transformed into a Java class method.

The step 803 is a process for checking whether or not the Java class includes the SQL sentence. A class without the SQL is set to be a session bean candidate, and a class including the SQL is set to be an entity bean candidate.

The step 804 is a process for performing a clustering by checking a class relationship, e.g., an association relationship, an aggregation relationship and an inheritance relationship, between classes included in a class cluster.

The step 805, the step 806 and the step 807 are processes for extracting components of the session bean, i.e., the home interface, the remote interface and the bean class, respectively.

The step 808 is a process for performing a clustering on classes accessing to a same table depending on table names of a database.

The steps 810 to 815 are processes for extracting the finder method, the EJB essential method, the primary key class, the home interface, the remote interface and the bean class, respectively.

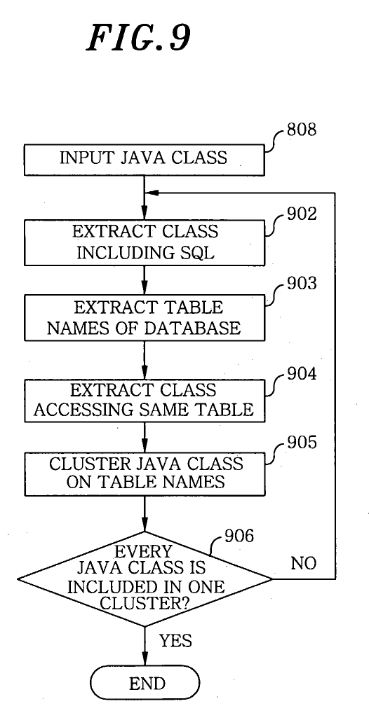

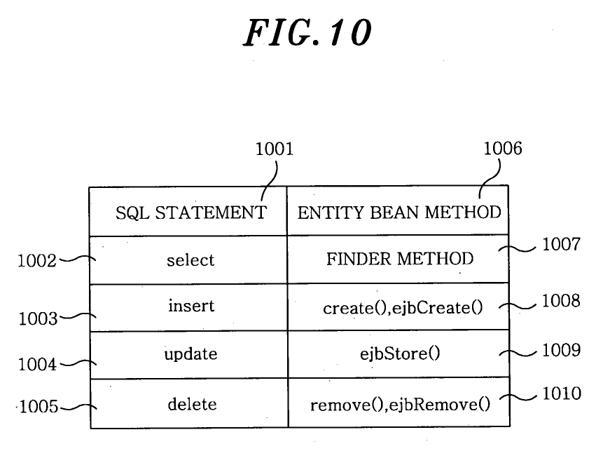

FIG. 9 shows a flow chart for demonstrating a Java class clustering for the entity bean in accordance with the present invention.

The clustering process for the entity bean involves inputting Java classes (step 901), extracting a Java class including a SQL statement (step 902), extracting table names of a database (step 903), extracting classes accessing to a same table (step 904), performing a Java class clustering according to a table name (step 905), and checking whether or not every Java class is processed (step 906).

The step 902 is a process for extracting a Java class including the SQL statement from the inputted Java classes. The corresponding classes are extracted as the entity bean.

The step 903 is a process for extracting a table name accessed by the SQL statement of the Java class.

The step 904 is a process for extracting classes accessing to a same database table.

The step 905 is a process for performing the Java class clustering according to table names.

The step 906 is a process for checking whether or not every Java class is included in one cluster.

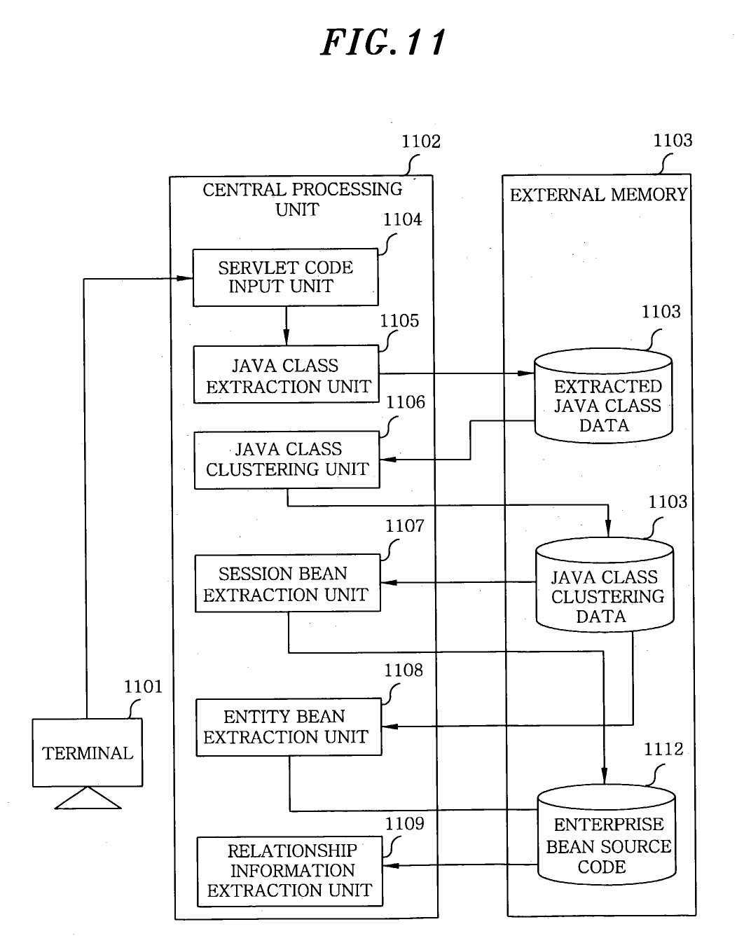

FIG. 10 depicts a table for showing a mapping relation between a SQL statement and an entity bean method in accordance with the present invention. To be more specific, “select” 1002 is mapped with a finder method 1007 for searching an entity bean, “insert” 1003 with a create( ), ejbCreate( ) method 1008 for creating an entity bean, “update” 1004 with an ejbStore( ) method 1009 for updating variables of the entity bean, and “delete” 1005 with a remove( ), ejbRemove( ) method 1010 for deleting the entity bean.

FIG. 11 illustrates an exemplary drawing for explaining an operation of the enterprise bean extraction apparatus in accordance with the present invention.

As illustrated in FIG. 11, the enterprise bean extraction apparatus in accordance with the present invention includes a terminal 1101, a central processing unit 1102, and an external memory 1103.

When a servlet code is inputted to a servlet code input unit 1104 through the terminal 1101, a Java class extraction unit 1105 extracts a Java class from the inputted servlet code.

The extracted Java class is stored in a database 1110 and then inputted into a Java class clustering unit 1106. A result of the Java class clustering is stored in a Java class clustering database 1111.

The Java class clustering information is inputted into a session bean extraction unit 1107 and an entity bean extraction unit 1108 to thereby extract a session bean and an entity bean, respectively.

The extracted session bean and entity bean are stored in an enterprise bean source code database 1112. An enterprise bean relationship information extraction unit 1109 extracts relationship information between the extracted enterprise beans.

The enterprise bean extraction apparatus in accordance with the prior arts extracts enterprise beans in order to reuse a legacy system such as COBOL and PL/I. However, the enterprise bean extraction apparatus in accordance with the present invention extracts enterprise beans in order to reuse a servlet-based web program. Accordingly, it is possible to reduce time and costs for developing a web program.

While the invention has been shown and described with respect to the preferred embodiments, it will be understood by those skilled in the art that various changes and modifications may be made without departing from the spirit and scope of the invention as defined in the following claims.

What is claimed is:

1. An apparatus for extracting enterprise beans from a servlet source code, comprising:
a servlet source code input device for receiving the servlet source code and a Java class;
a Java class extraction device for extracting Java classes from the servlet source code inputted by the servlet source code input device;
a Java class clustering device for grouping the Java classes extracted by the Java class extraction device on the basis of interrelated classes;
a session bean extraction device for extracting a session bean from the classes clustered by the Java class clustering device;
an entity bean extraction device for extracting an entity bean from the classes clustered by the Java class clustering device; and
an enterprise bean relationship information extraction device for extracting relationship information between enterprise beans from the session bean and the entity bean respectively extracted by the session bean extraction device and the entity bean extraction device.

2. The apparatus of claim 1, wherein the servlet source code input device receives a web application composed of the servlet source code and the Java class.

3. The apparatus of claim 1, wherein the Java class extraction device extracts a new Java class by analyzing business logics included in the servlet source code.

4. The apparatus of claim 1, wherein the Java class clustering device includes:
a session bean clustering device for performing a clustering for the session bean; and
an entity bean clustering device for performing a clustering for the entity bean.

5. The apparatus of claim 4, wherein the session bean clustering device performs a clustering for the session bean by checking at least one relationship between classes included in a cluster among an association relationship, an aggregation relationship and an inheritance relationship.

6. The apparatus of claim 4, wherein the entity bean clustering device performs a clustering on classes accessing to a same table according to table names of a database.

7. The apparatus of claim 1, wherein the session bean extraction device includes:
a session bean class extraction unit for extracting a session bean class that is one of the components of the session bean;
a remote interface extraction unit for extracting a remote interface of the session bean; and
a home interface extraction unit for extracting a home interface of the session bean.

8. The apparatus of claim 1, wherein the entity bean extraction device includes:
an entity bean class extraction unit for extracting a session bean class that is one of the components of the entity bean;
a remote interface extraction unit for extracting a remote interface of the entity bean;
a home interface extraction unit for extracting a home interface of the entity bean;
a primary key extraction unit for extracting a primary key of the entity bean; and
a finder method extraction unit for extracting a finder method that is one of the methods of the entity bean.

9. A method for extracting enterprise beans from a servlet source code, comprising the steps of:
(a) receiving the servlet source code and a Java class;
(b) extracting the Java class from the servlet source code;
(c) checking whether or not a structured query language (SQL) statement is included in the extracted Java class;
(d) extracting a session bean from the Java class if it is checked in the step (c) that the SQL statement is not included in the Java class; and
(e) extracting an entity bean from the Java class if it is checked in the step (c) that the SQL statement is included in the Java class.

10. The method of claim 9, wherein the step (b) includes the steps of:
(b1) removing a hypertext markup langue (HTML) code;
(b2) removing a code using a servlet application program interface (API); and
(b3) transforming a servlet method into a Java class method for processing a request of a client.

11. The method of claim 9, wherein the step (d) includes the steps of:
(d1) performing a Java class clustering for extracting a session bean based on an association relationship, an aggregation relationship and an inheritance relationship between classes;
(d2) extracting a session bean home interface;
(d3) extracting a session bean remote interface; and
(d4) extracting a session bean class.

12. The method of claim 9, wherein the step (e) includes the steps of:
(e1) performing a Java class clustering for extracting an entity bean;
(e2) extracting a finder method of the entity bean;
(e3) extracting an essential method of the entity bean;
(e4) extracting a primary key class of the entity bean;
(e5) extracting a home interface of the entity bean;
(e6) extracting a remote interface of the entity bean; and
(e7) extracting a bean class of the entity bean.

13. The method of claim 12, wherein the step (e1) includes the steps of:
(e11) analyzing a SQL statement included in a Java class;
(e12) extracting a table name of a database from the analyzed SQL sentence;
(e13) extracting a Java class accessing to a same table based on the extracted table name; and
(e14) performing a clustering on the extracted Java class according to table names.
